(19) United States
(12) Patent Application Publication
(10) Pub. No.: US 2019/0268255 A1
(43) Pub. Date: Aug. 29, 2019

(54) COMMUNICATION CIRCUIT SUPPORTING BUILT-IN TEST (BIT) IN A WIRELESS DISTRIBUTION SYSTEM (WDS)

(71) Applicant: Corning Optical Communications Wireless Ltd, Airport City (IL)

(72) Inventors: Ohad Kazav, Petah TIkva (IL); Maor Saig, Shaarey-Tikva (IL)

(21) Appl. No.: 15/904,869

(22) Filed: Feb. 26, 2018

(51) Int. Cl. H04L 12/26; H04L 29/08

(52) U.S. Cl. CPC H04L 43/50; H04L 27/2628; H04L 67/10; H04L 43/16

(57) ABSTRACT

A communication circuit supporting built-in test (BIT) in a wireless distribution system (WDS) is provided. The communication circuit includes a transmit circuit and a receive circuit. The transmit circuit is reconfigured to generate a radio frequency (RF) transmit signal having a predetermined signal characteristic(s) and provide the RF transmit signal to the receive circuit as an RF receive signal. A signal control and processing circuit in the communication circuit analyzes the predetermined signal characteristic(s) associated with the RF receive signal to determine whether the predetermined signal characteristic(s) conforms to a predefined pass/failure criteria(s). By reconfiguring the existing transmit and receive circuits to support the BIT, it is possible to conduct the BIT without requiring external test equipment being connected to the communication circuit. As a result, it is possible to significantly reduce cycle time of the BIT, while improving effectiveness, accuracy, and reliability of the BIT in the communication circuit.

### BACKGROUND

The disclosure relates generally to wireless distribution systems (WDSs), such as distributed antenna systems (DASs), remote radio head (RRH) systems, and small radio cell systems, and more particularly to performing built-in test (BIT) in the WDS.

Wireless customers are increasingly demanding wireless communications services, such as cellular communications services and Wireless Fidelity (WiFi) services. Thus, small cells, and more recently WiFi services, are being deployed indoors. At the same time, some wireless customers use their wireless communications devices in areas that are poorly serviced by conventional cellular networks, such as inside certain buildings or areas where there is little cellular coverage. One response to the intersection of these two concerns has been the use of WDSs. Examples of WDSs include DASs, RRH systems, and small radio cell systems (e.g., femotcell systems). WDSs include remote units configured to receive and transmit downlink communications signals to client devices within the antenna range of the respective remote units. WDSs can be particularly useful when deployed inside buildings or other indoor environments where the wireless communications devices may not otherwise be able to effectively receive radio frequency (RF) signals from a source.

In this regard, FIG. 1 illustrates a wireless distributed system (WDS) 100 that is configured to distribute communications services to remote coverage areas 102(1)(1)-102(M)(N), where ‘N’ is the number of remote coverage areas. The WDS 100 can be configured to support a variety of communications services that can include cellular communications services, wireless communications services, such as RF identification (RFID) tracking, WiFi, local area network (LAN), wireless LAN (WLAN), and wireless solutions (Bluetooth, WiFi Global Positioning System (GPS) signal-based, and others) for location-based services, and combinations thereof, as examples. For example, the WDS 100 may be a DAS or an RRH system. The remote coverage areas 102(1)(1)-102(M)(N) are created by and centered on remote units 104(1)(1)-104(M)(N) connected to a head-end unit (HEU) 106. The remote units 104(1)(1)-104(M)(N) are shown arranged in rows ‘1-M,’ each with columns ‘1-N’ for convenience, and are located in a building 108 or in an area of the building 108. The HEU 106 may be communicatively coupled to a base transceiver station (BTS) or a baseband unit (BBU). The HEU 106 receives downlink communications signals 112D from the BTS and/or the BBU to be communicated to the remote units 104(1)(1)-104(M)(N). The downlink communications signals 112D are communicated by the HEU 106 over a communications link 114 to the remote units 104(1)(1)-104(M)(N). The remote units 104(1)(1)-104(M)(N) are configured to receive the downlink communications signals 112D from the HEU 106 over the communications link 114. The remote units 104(1)(1)-104(M)(N) may include an RF transmitter/receiver (not shown) and a respective antenna operably connected to the RF transmitter/receiver to wirelessly distribute the communications services to user equipment 116 within their respective remote coverage areas 102(1)(1)-102(M)(N). The remote units 104(1)(1)-104(M)(N) are also configured to receive uplink communications signals 112U from the UE 116 in their respective remote coverage areas 102(1)(1)-102(M)(N) to be communicated to the HEU 106.

With continuing reference to FIG. 1, to ensure that the WDS 100 can distribute the downlink communications signals 112D and uplink communications signals 112U efficiently and reliably, a variety of tests are often performed on the HEU 106 and the remote units 104(1)(1)-104(M)(N) before and/or after being deployed in the WDS 100. A conventional approach for testing the HEU 106 and the remote units 104(1)(1)-104(M)(N) typically involves connecting external test equipment (e.g., signal generator, spectrum analyzer, etc.) to the HEU 106 and the remote units 104(1)(1)-104(M)(N) to enable signal injection and analysis. Notably, it may be necessary to connect the external test equipment to each of the HEU 106 and the remote units 104(1)(1)-104(M)(N) for testing the WDS 100 as a whole. In this regard, it would require a significant amount of human effort and cycle time to test all of the HEU 106 and the remote units 104(1)(1)-104(M)(N) in the WDS 100. Furthermore, the external test equipment may need to be calibrated and fine-tuned from time to time, thus further prolonging the cycle time of the testing. As such, it may be desired to test the HEU 106 and the remote units 104(1)(1)-104(M)(N) in the WDS 100 with improved efficiency and reduced cycle time.

No admission is made that any reference cited herein constitutes prior art. Applicant expressly reserves the right to challenge the accuracy and pertinency of any cited documents.

### SUMMARY

Embodiments of the disclosure relate to a communication circuit supporting built-in test (BIT) in a wireless distribution system (WDS). In examples discussed herein, the communication circuit can be provided in a head-end unit (HEU) and/or a remote unit(s) in the WDS to support BIT of the HEU and/or the remote unit(s). The communication circuit includes a transmit circuit and a receive circuit for transmitting and receiving a radio frequency (RF) signal(s), respectively. In this regard, the transmit circuit and the receive circuit can be reconfigured to support BIT without requiring that external test equipment be connected to the communication circuit. More specifically, the communication circuit can be configured to operate in a test mode operation. Accordingly, the transmit circuit is reconfigured to generate an RF transmit signal having a predetermined signal characteristic(s) and provide the RF transmit signal to the receive circuit as an RF receive signal. A signal control and processing circuit in the communication circuit analyzes the predetermined signal characteristic(s) associated with the RF receive signal to determine whether the predetermined signal characteristic(s) conforms to a predefined pass/failure criteria(s). By reconfiguring the existing transmit and receive circuits to support the BIT, it is possible to conduct the BIT without requiring that external test equipment be connected to the communication circuit. As a result, it is possible to significantly reduce cycle time of the BIT, while improving effectiveness, accuracy, and reliability of the BIT in the communication circuit.

In one exemplary aspect, a communication circuit in a WDS is provided. The communication circuit includes a transmit circuit having a transmit signal output. The transmit circuit is configured to output an RF transmit signal via the transmit signal output. The communication circuit also includes a receive circuit having a receive signal input. The receive circuit is configured to receive an RF receive signal via the receive signal input. The communication circuit also includes a signal control and processing circuit coupled to the transmit circuit and the receive circuit. The signal control and processing circuit is configured to configure the transmit circuit and the receive circuit to enter a test mode operation in response to receiving a test enable signal. The signal control and processing circuit is also configured to configure the transmit circuit to generate the RF transmit signal comprising at least one predetermined signal characteristic. The signal control and processing circuit is also configured to couple the transmit signal output to the receive signal input to provide the RF transmit signal from the transmit circuit to the receive circuit as the RF receive signal. The signal control and processing circuit is also configured to analyze the at least one predetermined signal characteristic associated with the RF receive signal in the receive circuit. The signal control and processing circuit is also configured to determine whether the at least one predetermined signal characteristic conforms to at least one predefined pass/failure criteria associated with the test mode operation.

An additional embodiment of the disclosure relates to a method for supporting BIT in a communication circuit in a WDS. The method includes configuring a transmit circuit and a receive circuit in the communication circuit to enter a test mode operation. The method also includes configuring the transmit circuit to generate an RF transmit signal comprising at least one predetermined signal characteristic. The method also includes providing the RF transmit signal from the transmit circuit to the receive circuit as an RF receive signal. The method also includes analyzing the at least one predetermined signal characteristic associated with the RF receive signal. The method also includes determining whether the at least one predetermined signal characteristic conforms to at least one predefined pass/failure criteria associated with the test mode operation.

An additional embodiment of the disclosure relates to a remote unit in a WDS. The remote unit includes a communication circuit. The communication circuit includes a transmit circuit having a transmit signal output. The transmit circuit is configured to output an RF transmit signal via the transmit signal output. The communication circuit also includes a receive circuit having a receive signal input. The receive circuit is configured to receive an RF receive signal via the receive signal input. The communication circuit also includes a signal control and processing circuit coupled to the transmit circuit and the receive circuit. The signal control and processing circuit is configured to configure the transmit circuit and the receive circuit to enter a test mode operation in response to receiving a test enable signal. The signal control and processing circuit is also configured to configure the transmit circuit to generate the RF transmit signal comprising at least one predetermined signal characteristic. The signal control and processing circuit is also configured to couple the transmit signal output to the receive signal input to provide the RF transmit signal from the transmit circuit to the receive circuit as the RF receive signal. The signal control and processing circuit is also configured to analyze the at least one predetermined signal characteristic associated with the RF receive signal in the receive circuit. The signal control and processing circuit is also configured to determine whether the at least one predetermined signal characteristic conforms to at least one predefined pass/failure criteria associated with the test mode operation.

An additional embodiment of the disclosure relates to an HEU in a WDS. The HEU includes a communication circuit. The communication circuit includes a transmit circuit having a transmit signal output. The transmit circuit is configured to output an RF transmit signal via the transmit signal output. The communication circuit also includes a receive circuit having a receive signal input. The receive circuit is configured to receive an RF receive signal via the receive signal input. The communication circuit also includes a signal control and processing circuit coupled to the transmit circuit and the receive circuit. The signal control and processing circuit is configured to configure the transmit circuit and the receive circuit to enter a test mode operation in response to receiving a test enable signal. The signal control and processing circuit is also configured to configure the transmit circuit to generate the RF transmit signal comprising at least one predetermined signal characteristic. The signal control and processing circuit is also configured to couple the transmit signal output to the receive signal input to provide the RF transmit signal from the transmit circuit to the receive circuit as the RF receive signal. The signal control and processing circuit is also configured to analyze the at least one predetermined signal characteristic associated with the RF receive signal in the receive circuit. The signal control and processing circuit is also configured to determine whether the at least one predetermined signal characteristic conforms to at least one predefined pass/failure criteria associated with the test mode operation.

An additional embodiment of the disclosure relates to a WDS. The WDS includes a plurality of remote units. The WDS also includes an HEU coupled to the plurality of remote units via a plurality of communications mediums, respectively. The HEU is configured to distribute a plurality of downlink communications signals to the plurality of remote units via the plurality of communication mediums, respectively. The HEU is also configured to receive a plurality of uplink communications signals from the plurality of remote units via the plurality of communication mediums, respectively. At least one of the HEU and the plurality of remote units includes a communication circuit. The communication circuit includes a transmit circuit having a transmit signal output. The transmit circuit is configured to output an RF transmit signal via the transmit signal output. The communication circuit also includes a receive circuit having a receive signal input. The receive circuit is configured to receive an RF receive signal via the receive signal input. The communication circuit also includes a signal control and processing circuit coupled to the transmit circuit and the receive circuit. The signal control and processing circuit is configured to configure the transmit circuit and the receive circuit to enter a test mode operation in response to receiving a test enable signal. The signal control and processing circuit is also configured to configure the transmit circuit to generate the RF transmit signal comprising at least one predetermined signal characteristic. The signal control and processing circuit is also configured to couple the transmit signal output to the receive signal input to provide the RF transmit signal from the transmit circuit to the receive circuit as the RF receive signal. The signal control and processing circuit is also configured to analyze the at least one predetermined signal characteristic associated with the RF receive signal in the receive circuit. The signal control and processing circuit is also configured to determine whether the at least one predetermined signal characteristic conforms to at least one predefined pass/failure criteria associated with the test mode operation.

Additional features and advantages will be set forth in the detailed description which follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding of the disclosure, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary indoor wireless distributed system (WDS) that includes an indoor cell neighboring an outdoor cell;

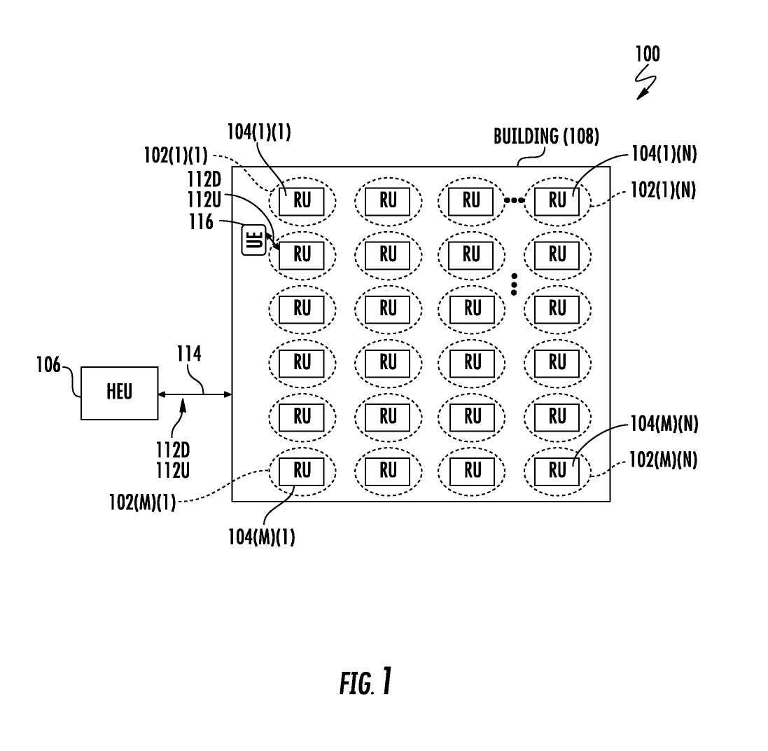

FIG. 2 is a schematic diagram of an exemplary communication circuit in which a transmit circuit and a receive circuit can be reconfigured to support built-in test (BIT) in the communication circuit without requiring that external test equipment be connected to the communication circuit;

FIG. 3 is a flowchart of an exemplary process for configuring the communication circuit of FIG. 2 to support the BIT without requiring that external test equipment be connected to the communication circuit;

FIG. 4 is a schematic diagram of an exemplary remote unit employing the communication circuit of FIG. 2 to support the BIT in the remote unit without requiring that external test equipment be connected to the remote unit;

FIG. 5 is a schematic diagram of an exemplary head-end unit (HEU) employing the communication circuit of FIG. 2 to support the BIT in the HEU without requiring that external test equipment be connected to the HEU;

FIG. 6 is a schematic diagram of an exemplary optical-fiber based WDS in which the remote unit of FIG. 4 and/or the HEU of FIG. 5 may be deployed to support the BIT with requiring external test equipment;

FIG. 7 is a partially schematic cut-away diagram of a building infrastructure employing the WDS of FIG. 6; and

FIG. 8 is a schematic diagram representation of additional detail illustrating a computer system that could be employed in the communication circuit of FIG. 2, the remote unit of FIG. 4, and the HEU of FIG. 5 to support BIT with requiring external equipment.

### DETAILED DESCRIPTION

Embodiments of the disclosure relate to a communication circuit supporting built-in test (BIT) in a wireless distribution system (WDS). In examples discussed herein, the communication circuit can be provided in a head-end unit (HEU) and/or a remote unit(s) in the WDS to support BIT of the HEU and/or the remote unit(s). The communication circuit includes a transmit circuit and a receive circuit for transmitting and receiving a radio frequency (RF) signal(s), respectively. In this regard, the transmit circuit and the receive circuit can be reconfigured to support BIT without requiring that external test equipment be connected to the communication circuit. More specifically, the communication circuit can be configured to operate in a test mode operation. Accordingly, the transmit circuit is reconfigured to generate an RF transmit signal having a predetermined signal characteristic(s) and provide the RF transmit signal to the receive circuit as an RF receive signal. A signal control and processing circuit in the communication circuit analyzes the predetermined signal characteristic(s) associated with the RF receive signal to determine whether the predetermined signal characteristic(s) conforms to a predefined pass/failure criteria(s). By reconfiguring the existing transmit and receive circuits to support the BIT, it is possible to conduct the BIT without requiring that external test equipment be connected to the communication circuit. As a result, it is possible to significantly reduce cycle time of the BIT, while improving effectiveness, accuracy, and reliability of the BIT in the communication circuit.

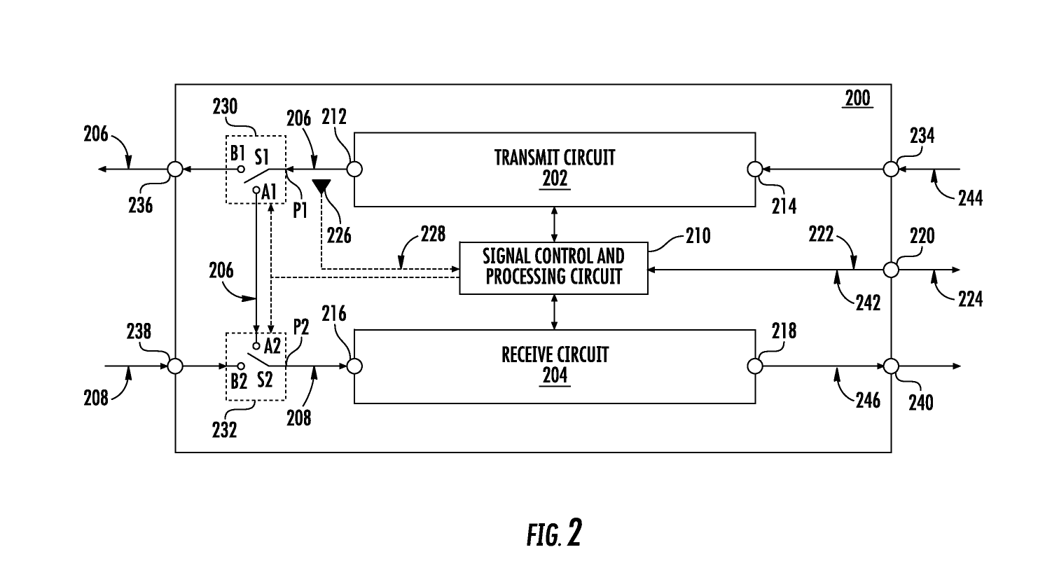

In this regard, FIG. 2 is a schematic diagram of an exemplary communication circuit 200 in which a transmit circuit 202 and a receive circuit 204 can be reconfigured to support BIT in the communication circuit 200 without requiring that external test equipment be connected to the communication circuit 200. In a non-limiting example, the BIT is a technique for enabling internal testing and verification of electronic modules and/or circuitries in the communication circuit 200. The BIT may be activated at the production line for verifying integrity of the electronic modules and/or circuitries before being integrated with other electronic modules and/or circuitries in the communication circuit 200. The BIT may also be activated in the field for diagnosing and troubleshooting the communication circuit 200.

As discussed below in detail, the communication circuit 200 can be controlled to support a normal mode operation and a test mode operation. During the normal mode operation, the transmit circuit 202 and the receive circuit 204 are configured to transmit an RF transmit signal 206 and receive an RF receive signal 208, respectively, in a WDS. In the test mode operation, the transmit circuit 202 is reconfigured to generate the RF transmit signal 206, and the receive circuit 204 is reconfigured to receive the RF transmit signal 206 as the RF receive signal 208. A signal control and processing circuit 210 is provided in the communication circuit 200 and coupled to the transmit circuit 202 and the receive circuit 204. The signal control and processing circuit 210 can be configured to analyze the RF receive signal 208 and determine whether a predetermined signal characteristic(s) (e.g., power level, frequency response, encoding/decoding, etc.) associated with the RF receive signal 208 conforms to a predefined pass/failure criteria(s) associated with the test mode operation. Thus, by reconfiguring the transmit circuit 202 and the receive circuit 204 to perform the BIT in the communication circuit 200, it may no longer be necessary to connect external test equipment to the communication circuit 200. Further, by deploying the communication circuit 200 in an HEU and/or a remote unit(s) in the WDS, it is possible to enable BIT in the HEU and/or the remote unit(s) without requiring that external test equipment be connected to the HEU and/or the remote unit(s). As a result, it is possible to significantly reduce cycle time of the BIT, while improving effectiveness, accuracy, and reliability of the BIT in the HEU and/or the remote unit(s) in the WDS.

The transmit circuit 202 can include a transmit signal output 212 and a transmit signal input 214. The receive circuit 204 can include a receive signal input 216 and a receive signal output 218. The communication circuit 200 may include a configuration input 220, which may be configured to couple the signal control and processing circuit 210 to an external computing device (e.g., laptop, desktop, smartphone, tablet, etc.). In a non-limiting example, the signal control and processing circuit 210 can configure the transmit circuit 202 and the receive circuit 204 to enter the test mode operation in response to receiving a test enable signal 222 via the configuration input 220. In the test mode operation, the signal control and processing circuit 210 may further receive a test command(s) via the configuration input 220 and carry out the BIT based on the received test command(s).

In this regard, in the test mode operation, the signal control and processing circuit 210 configures the transmit circuit 202 to generate the RF transmit signal 206 that includes at least one predetermined signal characteristic. The signal control and processing circuit 210 couples the transmit signal output 212 of the transmit circuit 202 to the receive signal input 216 of the receive circuit 204 such that the RF transmit signal 206 is provided from the transmit circuit 202 to the receive circuit 204 as the RF receive signal 208. Thus, the signal control and processing circuit 210 can analyze the predetermined signal characteristic associated with the RF receive signal 208 to determine whether the predetermined signal characteristic conforms to at least one predefined pass/failure criteria.

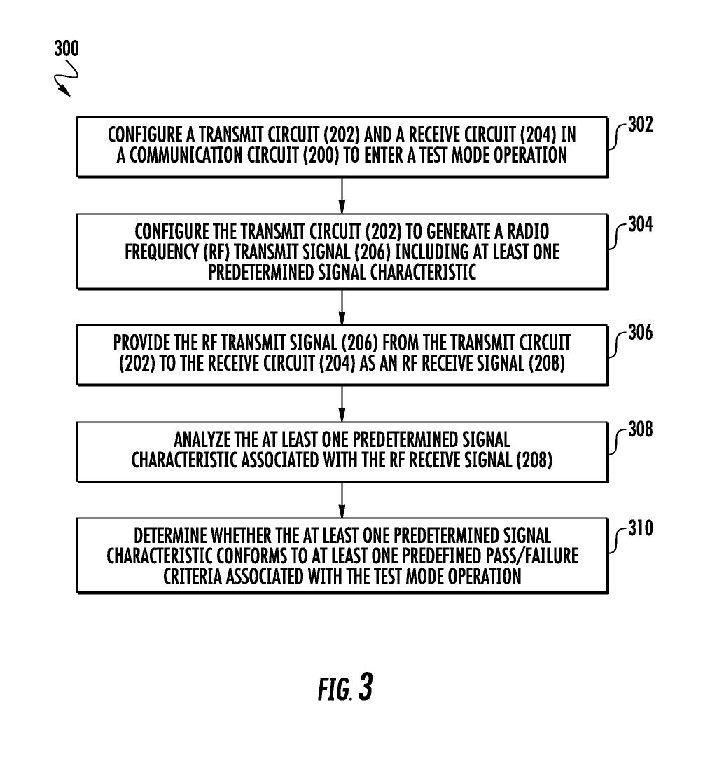

The communication circuit 200 may be configured to support the BIT in the test mode operation based on a process. In this regard, FIG. 3 is a flowchart of an exemplary process 300 for configuring the communication circuit 200 of FIG. 2 to support the BIT without requiring that external test equipment be connected to the communication circuit 200.

According to the process 300, the signal control and processing circuit 210 configures the transmit circuit 202 and the receive circuit 204 to enter the test mode operation in response to receiving the test enable signal 222 (block 302). Next, the signal control and processing circuit 210 configures the transmit circuit 202 to generate the RF transmit signal 206 having the predetermined signal characteristic (block 304). The signal control and processing circuit 210 then couples the transmit signal output 212 to the receive signal input 216 to provide the RF transmit signal 206 from the transmit circuit 202 to the receive circuit 204 as the RF receive signal 208 (block 306). The signal control and processing circuit 210 analyzes the predetermined signal characteristic associated with the RF receive signal 208 (block 308). Subsequently, the signal control and processing circuit 210 determines whether the predetermined signal characteristic conforms to the predefined pass/failure criteria associated with the test mode operation (block 310).

With reference back to FIG. 2, the signal control and processing circuit 210 may be further configured to generate a test indication signal 224 indicative of whether the predetermined signal characteristic conforms to the predefined pass/failure criteria. The signal control and processing circuit 210 may output the test indication signal 224 via the configuration input 220. The communication circuit 200 may be configured to perform the BIT to verify whether a number of predetermined signal characteristics conform to a number of predefined pass/failure criteria. Accordingly, the test indication signal 224 may include a test report indicative of whether each of the predetermined signal characteristics conforms to the predefined pass/failure criteria.

In one non-limiting example, the predetermined signal characteristic can correspond to a predetermined power level of the RF transmit signal 206. In this regard, the signal control and processing circuit 210 can control the transmit circuit 202 to generate the RF transmit signal 206 at the predetermined power level (e.g., 23 dBm). Accordingly, the signal control and processing circuit 210 can measure the predetermined power level associated with the RF receive signal 208 to determine whether the predetermined power level conforms to (e.g., is greater than or equal to) a predefined power threshold.

The communication circuit 200 may include a power detector 226, which may be provided in proximity to the transmit signal output 212 to detect a power level of the RF transmit signal 206 generated by the transmit circuit 202. The power detector 226 may provide a power level indication 228 indicative of the detected power level at the transmit signal output 212 to the signal control and processing circuit 210. In this regard, the signal control and processing circuit 210 can first compare the detected power level associated with the power level indication 228 against the predefined power threshold to rule out any functional issues associated with the transmit circuit 202. Subsequently, the signal control and processing circuit 210 can further determine whether the predetermined power level associated with the RF receive signal 208 conforms to the predefined power threshold.

In another non-limiting example, the signal control and processing circuit 210 can control the transmit circuit 202 to generate the RF transmit signal 206 at a predetermined frequency. Subsequently, the signal control and processing circuit 210 can determine whether the RF receive signal 208 is received by the receive circuit 204 at the predetermined frequency.

In another non-limiting example, the signal control and processing circuit 210 can control the transmit circuit 202 to generate the RF transmit signal 206 having a predetermined code word. Accordingly, the signal control and processing circuit 210 can analyze the RF receive signal 208 to determine whether the predetermined code word is received correctly by the receive circuit 204.

Notably, the BIT examples described above are by no means exhaustive. It should be appreciated that the communication circuit 200 can be configured to support additional BIT scenarios individually, sequentially, or concurrently.

The communication circuit 200 may include first switching circuitry 230 and second switching circuitry 232. The first switching circuitry 230 and the second switching circuitry 232 are both coupled to and can be controlled by the signal control and processing circuit 210. In a non-limiting example, the first switching circuitry 230 includes a first single pole, double throw (SP2T) switch S1, and the second switching circuitry 232 includes a second SP2T switch S2. The first SP2T switch S1 has a first pole port P1 coupled to the transmit signal output 212, and a pair of first throw ports A1, B1. The second SP2T switch S2 has a second pole port P2 coupled to the receive signal input 216, and a pair of second throw ports A2, B2. The first throw port Al is coupled to the second throw port A2.

In this regard, in response to receiving the test enable signal 222, the signal control and processing circuit 210 can concurrently control the first switching circuitry 230 and the second switching circuitry 232 to couple the transmit signal output 212 to the receive signal input 216. More specifically, the signal control and processing circuit 210 controls the first SP2T switch S1 to couple the first pole port P1 to the first throw port Al, and controls the second SP2T switch S2 to couple the second pole port P2 to the second throw port A2. As a result, the RF transmit signal 206 can propagate from the transmit signal output 212 to the receive signal input 216 via the first SP2T switch S1 and the second SP2T switch S2.

The communication circuit 200 can include a digital signal input port 234, an RF signal output port 236, an RF signal input port 238, and a digital signal output port 240. The RF signal output port 236 is coupled to the first throw port B1 of the first SP2T switch S1. The RF signal input port 238 is coupled to the second throw port B2 of the second SP2T switch S2.

The signal control and processing circuit 210 may configure the transmit circuit 202 and the receive circuit 204 to exit the test mode operation and enter a normal mode operation in response to receiving a test disable signal 242 via the configuration input 220. In this regard, the signal control and processing circuit 210 controls the first SP2T switch S1 to couple the first pole port P1 to the first throw port B1 and controls the second SP2T switch S2 to couple the second pole port P2 to the second throw port B2.

In this normal mode operation, the transmit circuit 202 receives a digital transmit signal 244 via the digital signal input port 234, which can be a digital baseband signal generated by such digital signal source as a digital baseband unit (BBU) and encoded based on such digital communication protocol as common public radio interface (CPRI). The transmit circuit 202 converts the digital transmit signal 244 into the RF transmit signal 206 and provides the RF transmit signal 206 to the RF signal output port 236 via the first SP2T switch S1. The receive circuit 204, on the other hand, receives the RF receive signal 208 from the RF signal input port 238 via the second SP2T switch S2. The receive circuit 204 converts the RF receive signal 208 into a digital receive signal 246, which can be a digital baseband signal encoded based on CPRI for example, and provides the digital receive signal 246 to the digital signal output port 240.

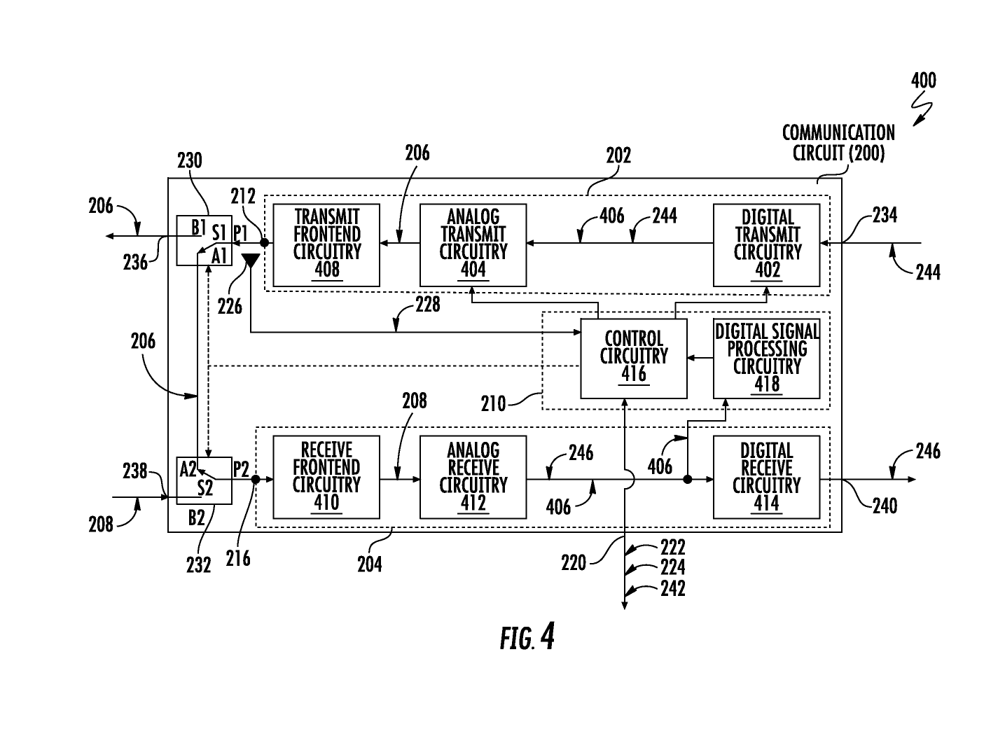

As previously mentioned, the communication circuit 200 may be provided in a remote unit(s) in the WDS to enable BIT in the remote unit(s) without requiring that external test equipment be connected to the remote unit(s). In this regard, FIG. 4 is a schematic diagram of an exemplary remote unit 400 employing the communication circuit 200 of FIG. 2 to support the BIT in the remote unit 400 without requiring that external test equipment be connected to the remote unit 400. Common elements between FIGS. 2 and 4 are shown therein with common element numbers and will not be re-described herein.

With reference to FIG. 4, the transmit circuit 202 includes digital transmit circuitry 402 and analog transmit circuitry 404. In the test mode operation, the digital transmit circuitry 402 is configured to generate the digital transmit signal 244 that includes a plurality of digital baseband samples 406 and is associated with the predetermined signal characteristic. In the normal mode operation, the digital transmit circuitry 402 is configured to receive the digital transmit signal 244 from the digital signal input port 234. The digital transmit circuitry 402 may be configured to de-capsulate the digital receive signal 244 into the digital baseband samples 406 and perform such digital processing as digital filtering and digital pre-distortion (DPD) on the digital baseband samples 406. The analog transmit circuitry 404 is configured to convert the digital transmit signal 244 into the RF transmit signal 206. The transmit circuit 202 may also include transmit frontend circuitry 408 configured to filter and/or amplify the RF transmit signal 206.

The receive circuit 204 includes receive frontend circuitry 410, which may include a receive filter(s) and/or a low-noise amplifier (LNA), to perform RF filtering on the RF receive signal 208. The receive circuit 204 also includes analog receive circuitry 412 and digital receive circuitry 414. The analog receive circuitry 412 is configured to receive the RF receive signal 208 and convert the RF receive signal 208 into the digital baseband samples 406. The digital receive circuitry 414, which may be operational only in the normal mode operation, converts the digital baseband samples 406 into the digital receive signal 246 and provides the digital receive signal 246 to the digital signal output port 240.

Notably, the receive filter(s) in the receive frontend circuitry 410 can be a wideband filter(s) configured to pass the RF receive signal 208 in both a receive frequency spectrum (e.g., a receive band) and a transmit frequency spectrum (e.g., a transmit band), while rejecting the RF receive signal 208 outside the receive frequency spectrum and the transmit frequency spectrum. In this regard, if the analog receive circuitry 412 does not receive the RF receive signal 208, it would be an indication that the RF receive signal 208 is different than the predetermined frequency associated with the RF transmit signal 206, and thus not conforming to the predefined pass/failure criteria with respect to the predetermined frequency.

The signal control and processing circuit 210 includes control circuitry 416, which can be a microprocessor, a microcontroller, or a field-programmable gate array (FPGA) for example. The control circuitry 416 configures the transmit circuit 202, the receive circuit 204, the first switching circuitry 230, and the second switching circuitry 232 to engage the remote unit 400 in the test mode operation in response to receiving the test enable signal 222.

In the test mode operation, the control circuitry 416 controls the digital transmit circuitry 402 to generate the digital transmit signal 244 including the digital baseband samples 406. The control circuitry 416 also controls the analog transmit circuitry 404 to convert the digital transmit signal 244 into the RF transmit signal 206, which includes the predetermined signal characteristic. The control circuitry 416 further controls the first switching circuitry 230 and the second switching circuitry 232 to couple the transmit signal output 212 to the receive signal input 216 to provide the RF transmit signal 206 from the transmit circuit 202 to the receive circuit 204 as the RF receive signal 208.

The signal control and processing circuit 210 may include digital signal processing circuitry 418, which can be a digital signal processor (DSP) or a FPGA for example. In the test mode operation, the digital signal processing circuitry 418 is configured to receive and analyze the digital baseband samples 406 associated with the digital receive signal 246 to determine whether the predetermined signal characteristic conforms to the predefined pass/failure criteria. In a non-limiting example, the digital signal processing circuitry 418 performs Fast Fourier Transform (FFT) on the digital baseband samples 406 to determine whether the predetermined signal characteristic conforms to the predefined pass/failure criteria.

The control circuitry 416 also configures the transmit circuit 202, the receive circuit 204, the first switching circuitry 230, and the second switching circuitry 232 to engage the remote unit 400 in the normal mode operation in response to receiving the test disable signal 242. In the normal mode operation, the digital transmit circuitry 402 is configured to receive the digital transmit signal 244 from the digital signal input port 234 and de-capsulate the digital transmit signal 244 into the digital baseband samples 406. The analog transmit circuitry 404 is configured to convert the digital transmit signal 244 into the RF transmit signal 206 and provide the RF transmit signal 206 to the transmit frontend circuitry 408, which in turn provides the RF transmit signal 206 to the transmit signal output 212. The receive frontend circuitry 410 receives the RF receive signal 208 from the receive signal input 216 and provides the RF receive signal 208 to the analog receive circuitry 412. The analog receive circuitry 412 converts the RF receive signal 208 into the digital receive signal 246. The digital receive circuitry 414 may perform such digital processing as digital filtering and/or DPD on the digital receive signal 246 and provide the digital receive signal 246 to the digital signal output port 240.

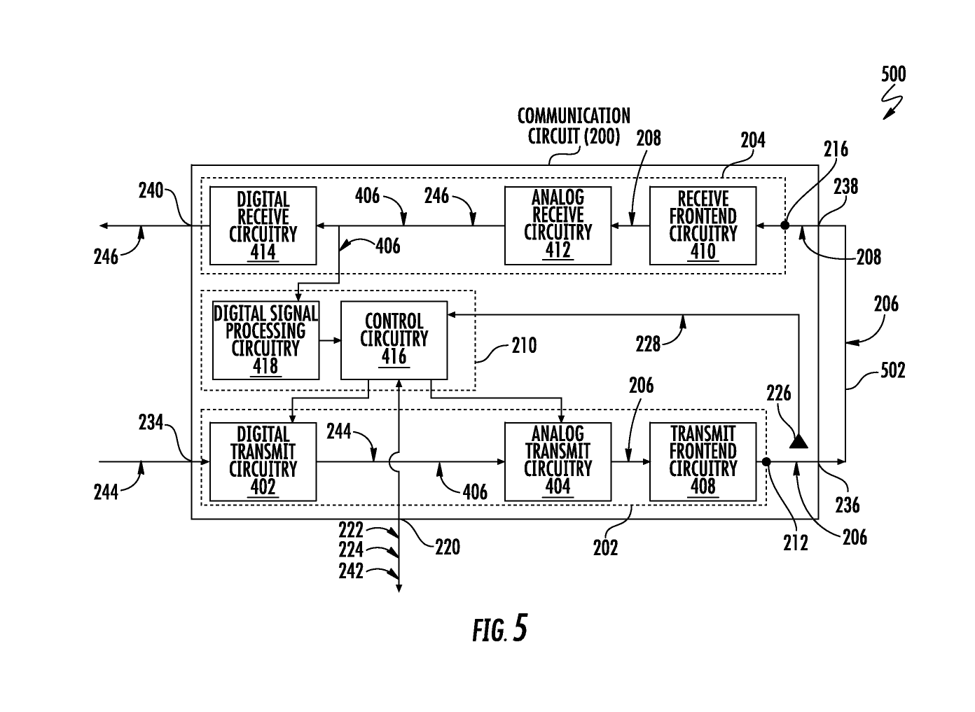

Also as previously mentioned, the communication circuit 200 may be provided in an HEU in the WDS to enable BIT in the remote unit(s) without requiring that external test equipment be connected to the remote unit(s). In this regard, FIG. 5 is a schematic diagram of an exemplary HEU 500 employing the communication circuit 200 of FIG. 2 to support the BIT in the HEU 500 without requiring that external test equipment be connected to the HEU 500. Common elements between FIGS. 2, 4, and 5 are shown therein with common element numbers and will not be re-described herein.

In one non-limiting example, in the test mode operation, the RF signal output port 236 can be coupled to the RF signal input port 238 via a jumper cable 502 (e.g., coaxial cable) such that the RF transmit signal 206 can be provided from the transmit circuit 202 to the receive circuit 204 as the RF receive signal 208. In another non-limiting example, the RF signal output port 236 can be coupled to the RF signal input port 238 via the first switching circuitry 230 and the second switching circuitry 232 of FIG. 2.

Note that any of the communications signals, bands, and services described herein may be RF communications signals, bands, and services. Supported RF communications services in the WDSs disclosed herein can include any communications bands desired. Examples of communications services include, but are not limited to, the US Cellular band, Personal Communication Services (PCS) band, Advanced Wireless Services (AWS) band, 700 MHz band, Global System for Mobile communications (GSM) 900, GSM 1800, and Universal Mobile Telecommunication System (UMTS). The communications bands may include licensed US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink). Further, the WDS can be configured to support any wireless technologies desired, including but not limited to Code Division Multiple Access (CDMA), CDMA200, 1×RTT, Evolution—Data Only (EV-DO), UMTS, High-speed Packet Access (HSPA), GSM, General Packet Radio Services (GPRS), Enhanced Data GSM Environment (EDGE), Time Division Multiple Access (TDMA), Long Term Evolution (LTE), iDEN, and Cellular Digital Packet Data (CDPD).

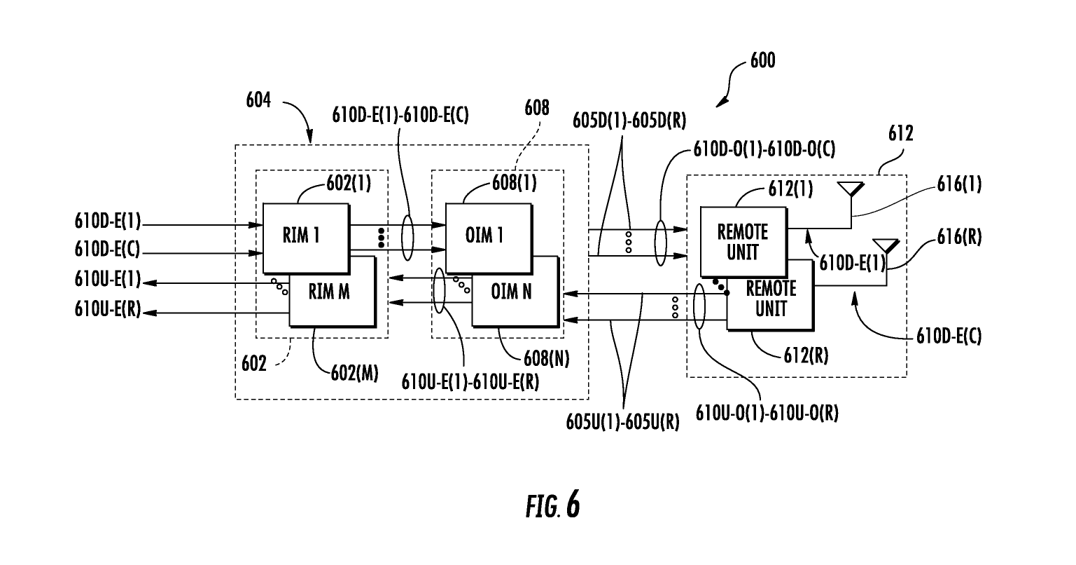

The remote unit 400 of FIG. 4 and/or the HEU 500 of FIG. 5 configured to support BIT without requiring external test equipment can be provided in an optical-based WDS. In this regard, FIG. 6 is a schematic diagram of such an exemplary optical-fiber based WDS 600. The optical-fiber based WDS 600 is comprised of three (3) main components. One or more radio interfaces provided in the form of radio interface modules (RIMs) 602(1)-602(M) are provided in a central unit 604, which can be functionally equivalent to the HEU 500 of FIG. 5, to receive and process RF downlink communications signals 610D-E(1)-610D-E(C) prior to optical conversion into optical downlink communications signals. In a non-limiting example, at least one of the RF downlink communications signals 610D-E(1)-610D-E(C) includes the RF transmit signal 206 of FIGS. 4 and 5. The RIMs 602(1)-602(M) provide both downlink and uplink interfaces for signal processing. The notations “1-M” and “1-C” indicate that any number of the referenced component, 1-M and 1-C, respectively, may be provided.

With continuing reference to FIG. 6, the central unit 604 is configured to accept the RIMs 602(1)-602(M) as modular components that can easily be installed and removed or replaced in the central unit 604. In one embodiment, the central unit 604 is configured to support up to twelve (12) RIMs 602(1)-602(12). Each RIM 602(1)-602(M) can be designed to support a particular type of radio source or range of radio sources (i.e., frequencies) to provide flexibility in configuring the central unit 604 and the optical-fiber based WDS 600 to support the desired radio sources. For example, one RIM 602 may be configured to support the Personal Communication Services (PCS) radio band. Another RIM 602 may be configured to support the 700 MHz radio band. In this example, by inclusion of these RIMs 602, the central unit 604 could be configured to support and distribute communications signals, including those for the communications services and communications bands described above as examples.

The RIMs 602(1)-602(M) may be provided in the central unit 604 that support any frequencies desired, including but not limited to licensed US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink).

With continuing reference to FIG. 6, the RF downlink communications signals 610D-E(1)-610D-E(C) may be provided as downlink RF spectrum chunks to a plurality of optical interfaces provided in the form of optical interface modules (OIMs) 608(1)-608(N) in this embodiment to convert the unlicensed and/or licensed RF downlink communications signals 610D-E(1)-610D-E(C) into optical downlink communications signals 610D-0(1)-610D-0(C). The OIMs 608(1)-608(N) may be configured to provide one or more optical interface components (OICs) that contain optical-to-electrical (O-E) and electrical-to-optical (E-O) converters, as will be described in more detail below. The OIMs 608(1)-608(N) support the radio bands that can be provided by the RIMs 602(1)-602(M), including the examples previously described above.

The OIMs 608(1)-608(N) each include E-O converters to convert the RF downlink communications signals 610D-E(1)-610D-E(C) into the optical downlink communications signals 610D-0(1)-610D-0(C). The optical downlink communications signals 610D-O(1)-610D-O(C) are communicated over a plurality of downlink optical fiber communications mediums 605D(1)-605D(R) to a plurality of remote units 612(1)-612(R). In a non-limiting example, at least one of the remote units 612(1)-612(R) is functionally equivalent to the remote unit 400 of FIG. 4. O-E converters provided in the remote units 612(1)-612(R) convert the optical downlink communications signals 610D-O(1)-610D-O(C) back into the RF downlink communications signals 610D-E(1)-610D-E(C), which are provided to antennas 616(1)-616(R) in the remote units 612(1)-612(R) to user equipment (not shown) in the reception range of the antennas 616(1)-616(R).

E-O converters are also provided in the remote units 612(1)-612(R) to convert RF uplink communications signals 610U-E(1)-610U-E(R) received from user equipment (not shown) through the antennas 616(1)-616(R) into optical uplink communications signals 610U-O(1)-610U-O(R). In a non-limiting example, at least one of the RF uplink communications signals 610U-E(1)-610U-E(R) includes the RF receive signal 208 of FIGS. 4 and 5. The remote units 612(1)-612(R) communicate the optical uplink communications signals 610U-O(1)-610U-O(R) over a plurality of uplink optical fiber communications mediums 605U(1)-605U(R) to the OIMs 608(1)-608(N) in the central unit 604. The OIMs 608(1)-608(N) include O-E converters that convert the received optical uplink communications signals 610U-O(1)-610U-O(R) into RF uplink communications signals 610U-E(1)-610U-E(R), which are processed by the RIMs 602(1)-602(M) and provided as RF uplink communications signals 610U-E(1)-610U-E(R).

Note that the downlink optical fiber communications medium 605D(1)-605D(R) and uplink optical fiber communications medium 605U(1)-605U(R) connected to each remote unit 612(1)-612(R) may be a common optical fiber communications medium, wherein for example, wave division multiplexing (WDM) may be employed to provide the optical downlink communications signals 610D-O(1)-610D-O(C) and the optical uplink communications signals 610U-O(1)-610U-O(R) on the same optical fiber communications medium.

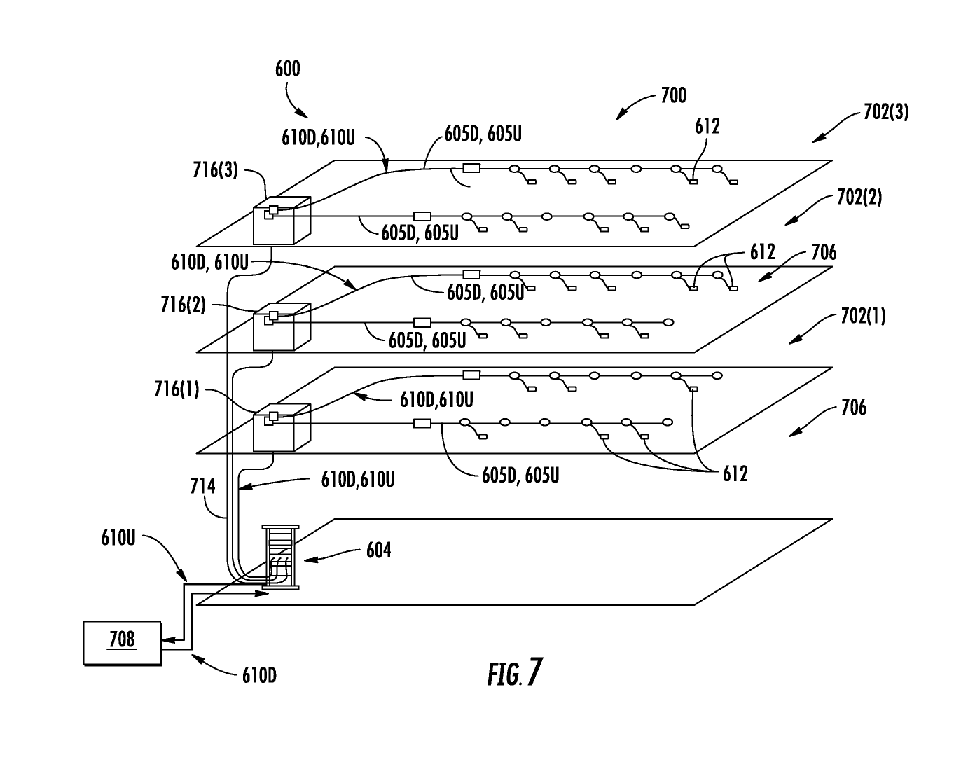

The optical-fiber based WDS 600 of FIG. 6 including the remote unit 400 of FIG. 4 and/or the HEU 500 of FIG. 5 configured to support BIT without requiring external test equipment can be provided in an indoor environment, such as illustrated in FIG. 7. In this regard, FIG. 7 is a partially schematic cut-away diagram of a building infrastructure 700 employing the WDS 600 of FIG. 6. The building infrastructure 700 in this embodiment includes a first (ground) floor 702(1), a second floor 702(2), and a third floor 702(3). The floors 702(1)-702(3) are serviced by the central unit 604 to provide antenna coverage areas 706 in the building infrastructure 700. The central unit 604 is configured to receive downlink communications signals 610D from a signal source 708. The central unit 604 is communicatively coupled to the remote units 612 to receive uplink communications signals 610U from the remote units 612, similar to as previously discussed above for other WDSs. The downlink and uplink communications signals 610D, 610U communicated between the central unit 604 and the remote units 612 are carried over a riser cable 714 in this example. The riser cable 714 may be routed through interconnect units (ICUs) 716(1)-716(3) dedicated to each floor 702(1)-702(3) that route the downlink and uplink communications signals 610D, 610U to the remote units 612 and also provide power to the remote units 612 via the downlink and uplink communications medium 605D, 605U.

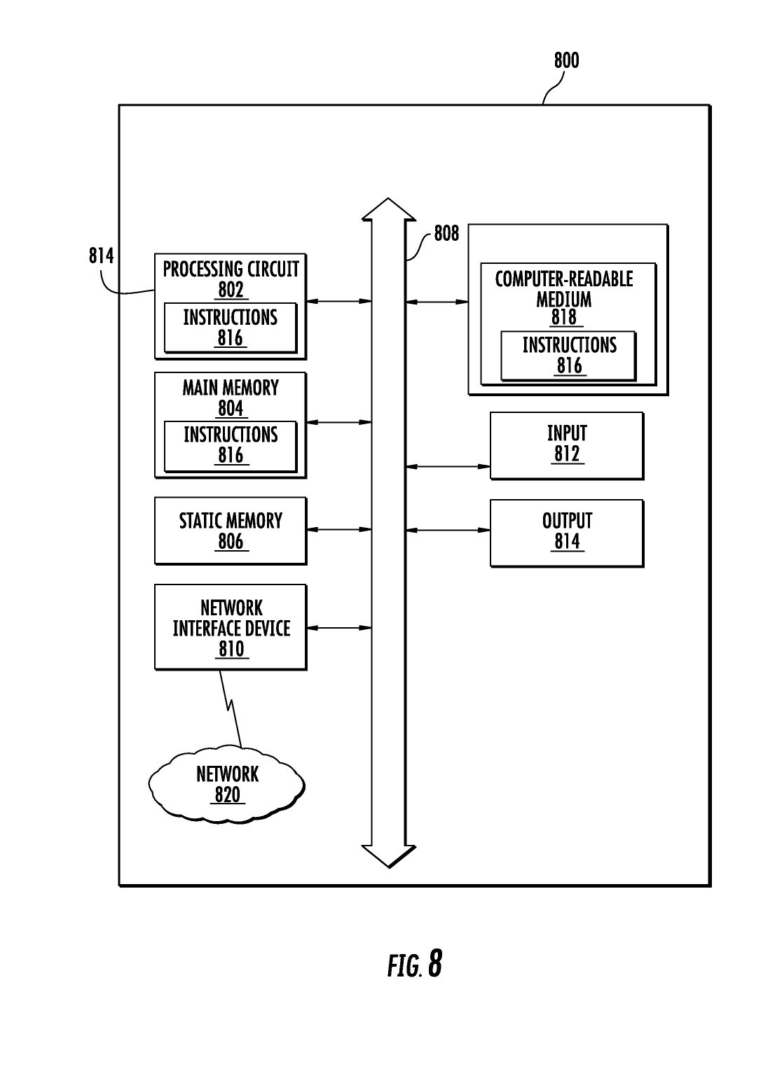

FIG. 8 is a schematic diagram representation of additional detail illustrating a computer system 800 that could be employed in the communication circuit 200 of FIG. 2, the remote unit 400 of FIG. 4, and the HEU 500 of FIG. 5 to support BIT with requiring external equipment. In this regard, the computer system 800 is adapted to execute instructions from an exemplary computer-readable medium to perform these and/or any of the functions or processing described herein.

In this regard, the computer system 800 in FIG. 8 may include a set of instructions that may be executed to program and configure programmable digital signal processing circuits in a WDS for supporting scaling of supported communications services. The computer system 800 may be connected (e.g., networked) to other machines in a LAN, an intranet, an extranet, or the Internet. While only a single device is illustrated, the term “device” shall also be taken to include any collection of devices that individually or jointly execute a set (or multiple sets) of instructions to perform any one or more of the methodologies discussed herein. The computer system 800 may be a circuit or circuits included in an electronic board card, such as, a printed circuit board (PCB), a server, a personal computer, a desktop computer, a laptop computer, a personal digital assistant (PDA), a computing pad, a mobile device, or any other device, and may represent, for example, a server or a user's computer.

The exemplary computer system 800 in this embodiment includes a processing circuit or processor 802, a main memory 804 (e.g., read-only memory (ROM), flash memory, dynamic random access memory (DRAM), such as synchronous DRAM (SDRAM), etc.), and a static memory 806 (e.g., flash memory, static random access memory (SRAM), etc.), which may communicate with each other via a data bus 808. Alternatively, the processor 802 may be connected to the main memory 804 and/or static memory 806 directly or via some other connectivity means. The processor 802 may be a controller, and the main memory 804 or static memory 806 may be any type of memory.

The processor 802 represents one or more general-purpose processing devices, such as a microprocessor, central processing unit, or the like. More particularly, the processor 802 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processor 802 is configured to execute processing logic in instructions for performing the operations and steps discussed herein.

The computer system 800 may further include a network interface device 810. The computer system 800 also may or may not include an input 812, configured to receive input and selections to be communicated to the computer system 800 when executing instructions. The computer system 800 also may or may not include an output 814, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 800 may or may not include a data storage device that includes instructions 816 stored in a computer-readable medium 818. The instructions 816 may also reside, completely or at least partially, within the main memory 804 and/or within the processor 802 during execution thereof by the computer system 800, the main memory 804 and the processor 802 also constituting computer-readable medium. The instructions 816 may further be transmitted or received over a network 820 via the network interface device 810.

While the computer-readable medium 818 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A communication circuit in a wireless distribution system (WIGS), comprising:
a transmit circuit comprising a transmit signal output, the transmit circuit configured to output a radio frequency (RF) transmit signal via the transmit signal output;
a receive circuit comprising a receive signal input, the receive circuit configured to receive an RF receive signal via the receive signal input; and
a signal control and processing circuit coupled to the transmit circuit and the receive circuit, the signal control and processing circuit configured to:
configure the transmit circuit and the receive circuit to enter a test mode operation in response to receiving a test enable signal;
configure the transmit circuit to generate the RF transmit signal comprising at least one predetermined signal characteristic;
couple the transmit signal output to the receive signal input to provide the RF transmit signal from the transmit circuit to the receive circuit as the RF receive signal;
analyze the at least one predetermined signal characteristic associated with the RF receive signal in the receive circuit; and
determine whether the at least one predetermined signal characteristic conforms to at least one predefined pass/failure criteria associated with the test mode operation.

2. The communication circuit of claim 1, wherein the signal control and processing circuit is further configured to generate a test indication signal indicative of whether the at least one predetermined signal characteristic conforms to the at least one predefined pass/failure criteria.

3. The communication circuit of claim 1, wherein the signal control and processing circuit is further configured to:
control the transmit circuit to generate the RF transmit signal at a predetermined power level; and
measure the predetermined power level associated with the RF receive signal to determine whether the predetermined power level conforms to a predefined power threshold.

4. The communication circuit of claim 3, further comprising a power detector, wherein:
the power detector is configured to detect a power level of the RF transmit signal at the transmit signal output and provide the detected power level to the signal control and processing circuit; and
the signal control and processing circuit is further configured to determine whether the predetermined power level conforms to the predefined power threshold based on the detected power level.

5. The communication circuit of claim 1, wherein the signal control and processing circuit is further configured to:
control the transmit circuit to generate the RF transmit signal at a predetermined frequency; and
determine whether the RF receive signal is received by the receive circuit at the predetermined frequency.

6. The communication circuit of claim 1, wherein the signal control and processing circuit is further configured to:
control the transmit circuit to generate the RF transmit signal comprising a predetermined code word; and
analyze the RF receive signal to determine whether the predetermined code word is received by the receive circuit.

7. The communication circuit of claim 1, wherein:
the transmit circuit further comprises:
digital transmit circuitry configured to generate a digital transmit signal comprising a plurality of digital baseband samples; and
analog transmit circuitry configured to convert the digital transmit signal into the RF transmit signal comprising the at least one predetermined signal characteristic and provide the RF transmit signal to the transmit signal output;
the receive circuit further comprises:
analog receive circuitry configured to receive the RF receive signal from the receive signal input and convert the RF receive signal into the plurality of digital baseband samples; and
digital receive circuitry configured to receive the plurality of digital baseband samples and generate a digital receive signal based on the plurality of digital baseband samples; and
the control and processing circuit comprises:
control circuitry configured to:
control the digital transmit circuitry to generate the digital transmit signal comprising the plurality of digital baseband samples;
control the analog transmit circuitry to convert the digital transmit signal into the RF transmit signal comprising the at least one predetermined signal characteristic; and
couple the transmit signal output to the receive signal input to provide the RF transmit signal from the transmit circuit to the receive circuit as the RF receive signal; and
digital signal processing circuitry configured to analyze the plurality of digital baseband samples associated with the digital receive signal to determine whether the at least one predetermined signal characteristic conforms to the at least one predefined pass/failure criteria.

8. The communication circuit of claim 7, wherein the digital signal processing circuitry is further configured to perform Fast Fourier Transform (FFT) on the plurality of digital baseband samples to determine whether the at least one predetermined signal characteristic conforms to the at least one predefined pass/failure criteria.

9. The communication circuit of claim 7, further comprising:
first switching circuitry coupled to the transmit signal output of the transmit circuit; and
second switching circuitry coupled to the first switching circuitry and the receive signal input of the receive circuit;
wherein, in the test mode operation, the control circuitry is further configured to control the first switching circuitry and the second switching circuitry to couple the transmit signal output to the receive signal input.

10. The communication circuit of claim 9, further comprising:
a digital signal input port configured to receive the digital transmit signal;
an RF signal output port configured to output the RF transmit signal;
an RF signal input port configured to receive the RF receive signal; and
a digital signal output port configured to output the digital receive signal.

11. The communication circuit of claim 10, wherein the control circuitry is further configured to:
configure the transmit circuit and the receive circuit to exit the test mode operation and to enter a normal mode operation in response to receiving a test disable signal;
control the first switching circuitry and the second switching circuitry to decouple transmit signal output of the transmit circuit from the receive signal input of the receive circuit;
couple the digital transmit circuitry to the digital signal input port to receive the digital transmit signal;
control the first switching circuitry to couple the transmit signal output to the RF signal output port to provide the RF transmit signal to the RF signal output port;
control the second switching circuitry to couple the receive signal input to the RF signal input port to receive the RF receive signal; and
couple the digital receive circuitry to the digital signal output port to provide the digital receive signal to the digital signal output port.

12. The communication circuit of claim 11, wherein:
the digital transmit circuitry is further configured to receive the digital transmit signal from the digital signal input port;
the analog transmit circuitry is further configured to convert the digital transmit signal into the RF transmit signal and provide the RF transmit signal to the transmit signal output;
the analog receive circuitry is further configured to receive the RF receive signal from the receive signal input and convert the RF receive signal into the digital receive signal; and
the digital receive circuitry is further configured to provide the digital receive signal to the digital signal output port.

13. The communication circuit of claim 1 provided in a remote unit in the WDS.

14. The communication circuit of claim 1 provided in a head-end unit (HEU) in the WDS.

15. A method for supporting built-in test (BIT) in a communication circuit in a wireless distribution system (WDS), comprising:
configuring a transmit circuit and a receive circuit in the communication circuit to enter a test mode operation;
configuring the transmit circuit to generate a radio frequency (RF) transmit signal comprising at least one predetermined signal characteristic;
providing the RF transmit signal from the transmit circuit to the receive circuit as an RF receive signal;
analyzing the at least one predetermined signal characteristic associated with the RF receive signal; and
determining whether the at least one predetermined signal characteristic conforms to at least one predefined pass/failure criteria associated with the test mode operation.

16. The method of claim 15, further comprising generating a test indication signal indicative of whether the at least one predetermined signal characteristic conforms to the at least one predefined pass/failure criteria.

17. The method of claim 15, further comprising:
controlling the transmit circuit to generate the RF transmit signal at a predetermined power level; and
measuring the predetermined power level associated with the RF receive signal to determine whether the predetermined power level conforms to a predefined power threshold.

18. The method of claim 17, further comprising:
detecting a power level of the RF transmit signal at a transmit signal output; and
determining whether the detected power level conforms to the predefined power threshold based on the detected power level.

19. The method of claim 15, further comprising:
controlling the transmit circuit to generate the RF transmit signal at a predetermined frequency;
coupling a transmit signal output to a receive signal input to provide the RF transmit signal from the transmit circuit to the receive circuit as the RF receive signal; and
determining whether the RF receive signal is received by the receive circuit at the predetermined frequency.

20. The method of claim 15, further comprising:
controlling the transmit circuit to generate the RF transmit signal comprising a predetermined code word;
coupling a transmit signal output to a receive signal input to provide the RF transmit signal from the transmit circuit to the receive circuit as the RF receive signal; and
analyzing the RF receive signal to determine whether the predetermined code word is received by the receive circuit.

21. The method of claim 15, further comprising:
generating a digital transmit signal comprising a plurality of digital baseband samples;
converting the digital transmit signal into the RF transmit signal comprising the at least one predetermined signal characteristic;
receiving the RF receive signal and converting the RF receive signal into the plurality of digital baseband samples; and
analyzing the plurality of digital baseband samples associated with a digital receive signal to determine whether the at least one predetermined signal characteristic conforms to the at least one predefined pass/failure criteria.

22. The method of claim 21, further comprising performing Fast Fourier Transform (FFT) on the plurality of digital baseband samples to determine whether the at least one predetermined signal characteristic conforms to the at least one predefined pass/failure criteria.

23.-26. (canceled)
